(19) United States
(12) Patent Application Publication
(10) Pub. No.: US 2007/0245016 A1
(43) Pub. Date: Oct. 18, 2007

(54) SYSTEM AND METHOD OF SINGLE-CHANNEL ACCOUNT REPORTING

(76) Inventors: Lian Li, Acton, MA (US); Min Jiang, Acton, MA (US)

Correspondence Address: Alcatel USA;Intellectual Property Department, 3400 W. Plano Parkway, M/S LEGL2, Plano, TX, 75075, US

(21) Appl. No.: 11/550,483

(22) Filed: Oct. 18, 2006

Related U.S. Application Data
(60) Provisional application No. 60/792,748, filed on Apr. 18, 2006.

(51) Int. Cl. G06F 15/173

(52) U.S. Cl. 709/224

(57) ABSTRACT

A system and method of single-channel account reporting between the data-path and the control-path in a packet switch or any charging device using a similar accounting scheme. The system framework includes a packet processing module for monitoring data flow within a data path, an accounting module within the control path, and at least one destination for processing an account report provided by the accounting module. The packet processing module generates a single copy of accounting information related to the data flow, which is provided to the accounting module at a time when a triggering event is required by the SCP/PPS, CGF, or both. The accounting module generates at least one account report from the accounting information and provides the account report to a destination in accordance with an identification element of the received accounting information.

### CROSS REFERENCE TO RELATED APPLICATION

This application claims priority of U.S. Provisional Patent Application No. 60/792,748, filed Apr. 18, 2006, the entire contents of which is hereby incorporated by reference.

### TECHNICAL FIELD

The present invention relates generally to a system and method of single-channel account reporting, and, in particular, to a system and method of single-channel account reporting within a content-based charging environment.

### BACKGROUND OF THE INVENTION

Within content-based charging environments, accounting information is often collected and reported or transferred between a data-path and a control-path. Indeed, a packet switch with charging functionality generally includes: 1) a data-path responsible for processing the incoming traffic data (data flow) and then forwarding the data to the destination output port toward an outside network, and 2) a control-path responsible for the connection signaling and traffic accounting for the data flow passing through the data-path.

In prepay applications, a connection (or call) between a client and server or proxy is established, which is followed by a service control point (SCP) or prepay server (PPS) within the control-path providing some predetermined thresholds to a packet processing module within the data-path. The predetermined thresholds generally relate to limits on the amount of bytes, packets, or time available to the client device, based on (pre-paid) credits acquired by the user of the client device. As a data flow passes through the data-path, the packet processing module monitors the data flow statistics (e.g., number of bytes, number of packets, and duration). When the monitored data flow statistics reach one of the predetermined thresholds, a triggering event occurs whereby the packet processing module provides accounting information to an accounting module of the control-path.

The accounting module generally processes the accounting information and generates multiple account reports to be sent to a SCP, PPS, and/or a charge gateway function (CGF). An account report sent to the SCP/PPS may request new threshold values from the SCP and PPS. An account report sent to the CGF may request the generation of call detail records (CDRs) from the CGF. Because the requirements of the account reports for the SCP/PPS are normally different from the account reports for the CGF, the accounting information associated with the SCP/PPS provided by the packet processing module to the account module is independent of the accounting information associated with the CGF provided by the packet processing module to the account module. In conventional systems, therefore, multiple independent reports of accounting information are provided by the packet processing module in the data-path to the account module in the control-path. This is true even if the reports include overlapping information or are generated at the same time, which is quite common in applications involving real-time streaming data. The number of multiple independent reports increases when there are multiple external charging modules connected to the same accounting module, because each charging module may have different requirements for account reports.

Such multi-channel account reporting often requires substantial resources within the control-path (even more so than the data-path) in the application of real-time streaming data, such as interactive video, streaming data, and gaming. The use of additional resources significantly decreases the capacity of packet switches for processing real-time streaming data due to the resources demanded by the data-path and control-path. When the control-path function and the data-path function are not located on the same electrical board, the use of resources is further increased, especially in situations where frequent accounting data transfers are required between boards. Unfortunately, the use of separate boards for the control-path function and the data-path function is not uncommon in the telecommunications industry.

What is needed, therefore, is a system and method of single-channel account reporting between the data-path and the control-path, whereby only one account report is provided by the packet processing module to the accounting module at any given time. It is to such a system and method that the present invention is primarily directed.

### BRIEF SUMMARY OF THE INVENTION

Briefly described, in preferred form, the present invention is a system and method of single-channel account reporting between the data-path and the control-path in a packet switch or any charging device using a similar accounting scheme. Generally, the system framework includes a packet processing module for monitoring data flow within a data path, an accounting module within the control path, and at least one destination (e.g., SCP/PPS or CGF) for processing an account report provided by the accounting module. If multiple accounting destinations such as SCP/PPS and CGF are supported, the data-path on the packet switch can monitor threshold-crossing according to the combined requirements of the SCP/PPS and CGF. The packet processing module generates accounting information related to the data flow. A single copy of the accounting information is provided to the accounting module. The accounting module within the control path generates at least one account report from the accounting information and provides the account report to the destination in accordance with an identification element of the received accounting information.

The packet processing module is also adapted to determine whether a predetermined threshold has been met or exceeded based on the monitored data flow. More specifically, the packet processing module determines whether the number of bytes, number of packets, or duration of data flow meets or exceeds a byte threshold, packet threshold, and time threshold, respectively. If a predetermined threshold has been met or exceeded, the packet processing module then provides the accounting information to the accounting module of the control-path.

The method of single-channel account reporting includes the monitoring of a data flow within a data-path, generating account information related to the data flow, determining from the account information whether any triggering event has occurred (e.g., any threshold required by SCP/PPS and/or CGF has been met or exceeded), and, if the triggering event has occurred, generating a first-level account report including an identification element, providing a single first-level account report to the control-path whether the triggering event is required by SCP/PPS, CGF, or both, and generating a second-level account report within the control-path to be provided to a predetermined destination in accordance with the identification element of the first-level account report.

The account information generated from the data flow can include byte information, packet information, and time information, such that a comparison can be made with predetermined thresholds which specify limits on the number of bytes, number of packets, and duration of data flow. The thresholds can be determined based on the prepaid credits of a user of the client device. When one of the predetermined thresholds is met or exceeded, a triggering event occurs, whereby the first-level account report is generated and provided to the control-path. In accordance with the identification element of the first-level account report, the second-level account report can be sent to a SCP/PPS, CGF, or a combination thereof.

These and other objects, features and advantages of the present invention will become more apparent upon reading the following specification in conjunction with the accompanying drawings.

### BRIEF DESCRIPTION OF THE FIGURES

FIG. 1 illustrates a block diagram representation of component structures of a framework for single-channel account reporting in accordance with preferred embodiments of the present invention.

FIG. 2 illustrates a block diagram representation of a computing environment which may be utilized in accordance with preferred embodiments of the present invention.

FIGS. 3A-3B, collectively known as FIG. 3, illustrate a logic flow diagram representing a first method of single-channel account reporting in accordance with preferred embodiments of the present invention.

FIGS. 4A-4C, collectively known as FIG. 4, illustrate a logic flow diagram representing a second method of single-channel account reporting in accordance with an exemplary embodiment of the present invention.

### DETAILED DESCRIPTION OF THE PREFERRED EMBODIMENTS

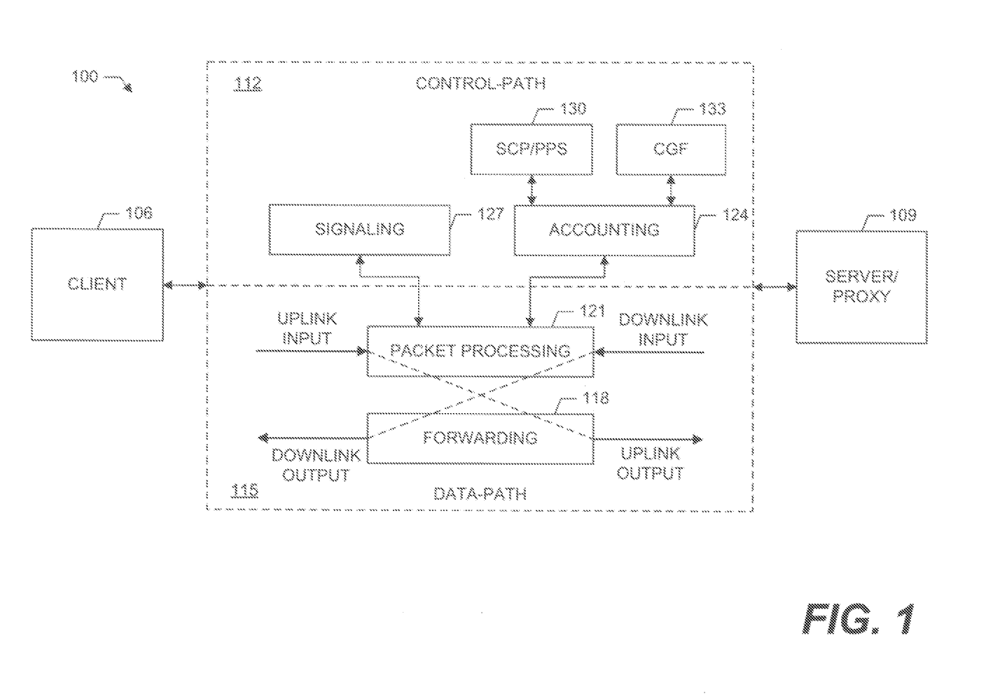

Referring now in detail to the drawing figures, wherein like reference numerals represent like parts throughout the several views, FIG. 1 displays component structures of a system 100 for single-channel account reporting within a content-based charging environment. The present invention reduces the bandwidth demanded by the transferring of account messages from the data-path 115 to the control-path 112 in a packet switch or any content-based charging device using a similar accounting scheme. Moreover, the present invention unifies the formats of the account reports for traffic statistics from the data-path 115 to the control-path 112, while utilizing a single-channel approach (e.g., ensuring that only one report is generated and transferred after a triggering event, rather than simultaneously transferring multiple reports) for the transfer of account reports from the data-path 115 to the control-path 112. Accordingly, the present invention employs a simple, but effective, method to synchronize the use of account reports for multiple purposes, thereby decreasing the data volume being transferred and, consequently, reducing the resources used in the control-path 112.

As illustrated in FIG. 1, a client system 106, or application thereon, desires to communicate, generally over a network, with a particular service or server 109. In the content-based charging environment, the client system 106 can be associated with a financial account, whereby certain, but not necessarily all, content-based services provided to the client system 106 are paid for by or charged to the financial account. Depending upon implementation, data flow through the client system 106 can be charged to the appropriate financial account according to the number of bytes transferred, the number of packets transferred, or the duration (e.g., time) of the data flow, or a combination thereof.

As is known by one skilled in the art, communications between the client system 106 and the server 109 generally use traditional protocols, whereby data is transferred between the client system 106 and the server 109 via a data-path 115. Generally, a packet processing module 121 associated with the client 106 is utilized to transform uploaded input (e.g., data sent from the client 106) into small packets to be forwarded by a forwarding module 118 to a predetermined destination, such as the server 109. Further, the packet processing module 121 can be utilized to combine the packets of downloaded input (e.g., data received by the client 106) into a data stream to be forwarded by the forwarding module 118 to the client 106.

The packet processing module 121 can also monitor the data flow between the client 106 and server 109. For example, the packet processing module 121 can monitor the number of bytes transferred, the number of packets transferred, and the duration (time) of data transfer between the server 109 and the client 106. When a triggering event occurs, the packet processing module 121, as described more fully below, can provide accounting information to the control-path for processing. The accounting information can include, for example and not limitation, the number of bytes transferred, the number of packets transferred, duration (time) of data transfer, or a combination thereof. A triggering event can occur when a predetermined threshold has been met or exceeded. The predetermined threshold, for example and not limitation, can include a maximum number of bytes, a maximum number of packets, and/or a maximum duration of data transfer.

To facilitate proper account management and data monitoring within a content-based charging environment, the system 100 of the present invention generally comprises a data-path 115 including a packet processing module 121 and a forwarding module 118, and a control-path 112 including a signaling module 127, an accounting module 124, a service control point and/or prepay server 130 (SCP/PPS), and a charge gateway function 133 (CGF). The client system 106 communicates with the server 109 by transferring data through the data-path 115. As data is transferred between the client system 106 and the server 109, account management is conducted in the control-path 112.

The packet processing module 121 of the data-path 115 is adapted to monitor the data flow within the data-path 115 between a first communication device (e.g., client 106) and a second communication device (e.g., server 109). As the packet processing module 121 monitors the data flow, the packet processing module 121 generates account information related to the data flow. The account information can include, but is not limited to, the number of bytes of data transferred, the number of packets of data transferred, and the duration (time) of data transferred.

The packet processing module 121 can receive at least one predetermined threshold related to the data flow from the control-path 112. In a first embodiment of the present invention, the predetermined threshold is associated with the maximum number of bytes of data that can be transferred. In a second embodiment of the present invention, the predetermined threshold is associated with the maximum number of packets that can be transferred. In yet a third embodiment of the present invention, the predetermined threshold is associated with the maximum time that data can be transferred. As the packet processing module 121 monitors the data flow in the data-path 115, the packet processing module 121 can determine whether a predetermined threshold related to the data flow has been met or exceeded.

If the packet processing module 121 determines that a predetermined threshold has been met or exceeded, the packet processing module 121 provides a first-level account report (e.g., accounting information) to the accounting module 124 of the control-path 112. In the present invention, the packet processing module 121 is adapted to provide a single first-level account report to the accounting module 124, when the triggering event is required by SCP/PPS 130, CGF 133, or both. Accordingly, only one unified account report (e.g., first-level account report), in a uniform format, is provided to the accounting module 124 by the packet processing module 121 at any given time. The first-level account report is formatted so that it can be properly utilized by the SCP/PPS, CGF, or a combination thereof.

The first-level account report can include accounting information, such as the number of bytes transferred, the number of packets transferred, the duration of time in which the data was transferred, an identification element indicating the ultimate destination of the accounting information, and at least one reset flag. For example, the account report can include a first reset flag associated with the byte information, a second reset flag associated with the packet information, and a third reset flag associated with the duration or time information. The reset flag determines how the control path 112 gathers the accounting data from the first-level account reports. If the reset flag is set, then the associated accounting data in the first-level account report is incremental to what was in the previous first-level report. If, however, the rest flag is not set, then the associated accounting data in the first-level account report is a replacement to what was in the previous first-level account report.

The accounting module 124 in the control-path 112 provides the packet processing module 121 in the data-path 115 with the predetermined thresholds related to the data flow. The accounting module 124 is also adapted to receive the single first-level account report from the packet processing module 121, when the triggering event is required by the SCP/PPS 130, CGF 133, or both. Moreover, the accounting module 124 utilizes the reset flags within the first account to generate at least one second-level report to be provided to a predetermined destination in accordance with the identification information or element of the first-level account report.

The predetermined destination (e.g., SCP/PPS 130 or CGF 133) processes the second-level account report corresponding to the account information of the first-level account report. The predetermined destination can include the SCP 130, the PPS 130, the CGF 133, or a combination thereof. One skilled in the art will recognize that the predetermined destination utilizes the second-level account report for the management of the financial account associated with a user of the client system 106.

The signaling module 127 in the control-path 112 is adapted to establish and maintain signal connections or calls between the client 106 and a service or server 109. The signaling module 127, for example, implements a routing protocol for telephony networks. Its function is similar to that of the transmission control protocol (TCP) on the Internet, such that when given an origination and destination address, the signaling module 127 assists in delivering messages to and receiving messages from the destination machine (e.g., server 109).

In conventional “multi-channel reporting” of the prior art, the packet processing unit 121 simultaneously transfers multiple independent account reports to the accounting module 124 for each resource accessed by the client 106. The multiple independent account reports include overlapping information and in different formats. The simultaneous transfer of a high-volume of account reports in multi-channel reporting is a large drain on the packet switch's (or other device's) capacity. Such a drain on the capacity of the packet switch increases for each resource accessed by the client 106. To free up resources in the control-path 112 and data-path 115, the present invention employs a single-channel reporting scheme, which unifies the content and format of the accounting information into a single account report by the packet processing module 121. The single account report can be interpreted by any of the accounting destinations, including the SCP/PPS 130 and the CGF 133. The single report is sent to the accounting module 124 when the triggering event is required by SCP/PPS 130, CGF 133, or both, thereby reducing the drain on the capacity of the packet switch. The accounting module 124 can then provide a second-level account report to all destinations indicated by the identification information within the account report provided by the packet processing module 121.

For example, and not limitation, Tables 1 illustrates an exemplary account report that would be generated by the packet processing unit 121 in the multi-channel reporting scheme of the prior art.

TABLE 1
Multi-channel Account Report (Prior Art)

```
{
  Module ID;
  Trigger Event Type;
  Accounting Action;
  Connection ID;
  Total Flow Number;
  // A flow means classified traffic, Total Flow Number = N; N>=0
  Unclassified Traffic {
    Prepaid Uplink Byte Count;
    Prepaid Downlink Byte Count;
    Prepaid Uplink Packet Count;
    Prepaid Downlink Packet Count;
    CDR Uplink Byte Count;
    CDR Downlink Byte Count;
    CDR Uplink Packet Count;
    CDR Downlink Packet Count;
    Time Duration;
  }
  Classified Traffic {
    Flow ID;
    Flow Instance ID;
    URL;
    Prepaid Uplink Byte Count;
    Prepaid Downlink Byte Count;
    Prepaid Uplink Packet Count;
    Prepaid Downlink Packet Count;
    CDR Uplink Byte Count;
    CDR Downlink Byte Count;
    CDR Uplink Packet Count;
    CDR Downlink Packet Count;
    Time Duration;
  } Flow_count_Array[ ];
}
```

Further, for exemplary purposes only, Table 2 illustrates an exemplary account report that would be generated by the packet processing unit 121 in the single-channel reporting scheme of the present invention. One skilled in the art will recognize that additional information can be provided within the reports without departing from the scope of the present invention.

TABLE 2
Single-Channel Account Report

```
{
  Trigger Event Type;
  Accounting Action;
  Charge Type;
  Connection ID;
  Total Flow Number;
  // A flow means a classified traffic, Total Flow Number = N; N>=0
  Unclassified Traffic {
    Identification Element;
    Count Flags{
      Byte Count Reset Flag;
      Packet Count Reset Flag;
      Time Count Reset Flag;
      CDR Flag;
    }
    Uplink Byte Count;
    Downlink Byte Count;
    Uplink Packet Count;
    Downlink Packet Count;
    Time Duration;
  }
  Classified Traffic {
    Identification Element;
    Flow ID;
    Flow Instance ID;
    URL;
    Count Flags{
      Byte Count Reset Flag;
      Packet Count Reset Flag;
      Time Count Reset Flag;
      CDR Flag;
    }
    Uplink Byte Count;
    Downlink Byte Count;
    Uplink Packet Count;
    Downlink Packet Count;
    Time Duration;
  } Flow_Count_Array[ ];
}
```

One skilled in the art will recognize that the forwarding module 118, packet processing module 121, signaling module 127, accounting module 124, SCP/PPS 130, CGF 133 and components thereof are configured with hardware and/or software appropriate to perform the tasks and provide capabilities and functionality as described herein.

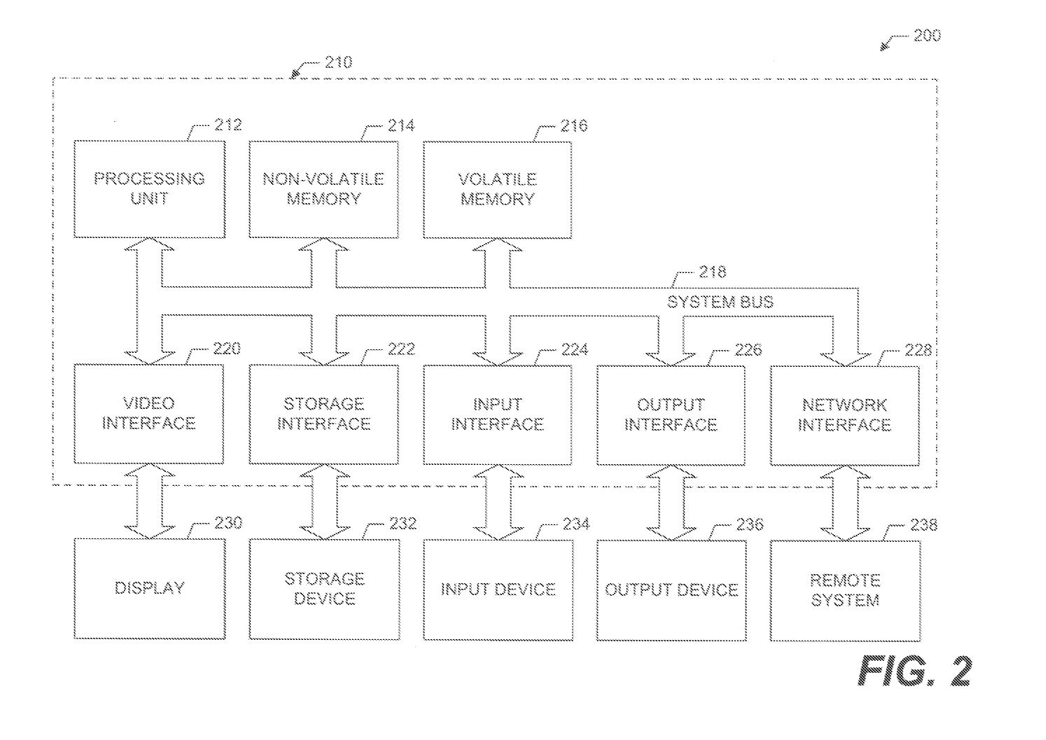

FIG. 2 displays a block diagram representation of a computing environment 200 which may be utilized in accordance with preferred embodiments of the present invention. More particularly, client system 106 and server 109 can utilize the computing environment 200 described herein. The client system 106 and server 109 of the present invention can include, but are not limited to, personal computers, mainframe computers, servers, hand-held or laptop devices, cellular phones, multiprocessor systems, microprocessor-based systems, set-top boxes, programmable consumer electronics, network PCs, minicomputers, distributed computing environments that include any of the above systems or devices, and the like. It should be understood, however, that the features and aspects of the present invention can be implemented by or into a variety of systems and system configurations and any examples provided within this description are for illustrative purposes only.

FIG. 2 and the following discussion provide a general overview of a platform onto which an embodiment of the present invention, or portions thereof, can be integrated, implemented and/or executed. Although reference has been made to instructions within a software program being executed by a processing unit, those skilled in the art will understand that at least some of the functions performed by the software can also be implemented by using hardware components, state machines, or a combination of any of these techniques. In addition, a software program which may implement an embodiment of the present invention can also run as a stand-alone program or as a software module, routine, or function call, operating in conjunction with an operating system, another program, system call, interrupt routine, library routine, or the like. The term program module is used herein to refer to software programs, routines, functions, macros, data, data structures, or any set of machine readable instructions or object code, or software instructions that can be compiled into such, and executed by a processing unit 212.

Turning now to the figure, computing device 210 may comprise various components including, but not limited to, a processing unit 212, a non-volatile memory 214, a volatile memory 216, and a system bus 218. The non-volatile memory 214 can include a variety of memory types including, but not limited to, read only memory (ROM), electronically erasable read only memory (EEROM), electronically erasable and programmable read only memory (EEPROM), electronically programmable read only memory (EPROM), electronically alterable read only memory (EAROM), FLASH memory, bubble memory, battery backed random access memory (RAM), compact disc read only memory (CDROM), digital versatile disc (DVD), or other optical disk storage, magnetic cassettes, magnetic tape, magneto-optical storage devices, magnetic disk storage or other magnetic storage devices, or any other medium which may be used to store the desired information. The non-volatile memory 214 can provide storage for power-on and reset routines (bootstrap routines) that are invoked upon applying power or resetting the computing device 210. In some configurations the non-volatile memory 214 can provide the basic input/output system (BIOS) routines that are utilized to perform the transfer of information between elements within the various components of the computing device 210.

The volatile memory 216 can include a variety of memory types and devices including, but not limited to, random access memory (RAM), dynamic random access memory (DRAM), synchronous dynamic random access memory (SDRAM), double data rate synchronous dynamic random access memory (DDR-SDRAM), bubble memory, registers, or the like. The volatile memory 216 can provide temporary storage for routines, modules, functions, macros, data, etc. that are being or may be executed by, or are being accessed or modified by, the processing unit 212.

Alternatively, the non-volatile memory 214 and/or the volatile memory 216 can be a remote storage facility accessible through a distributed network system. Additionally, the non-volatile memory 214 and/or the volatile memory 216 can be a memory system comprising a multi-stage system of primary and secondary memory devices, as described above. The primary memory device and secondary memory device can operate as a cache for each other or the second memory device can serve as a backup to the primary memory device. In yet another embodiment, the non-volatile memory 214 and/or the volatile memory 216 can comprise a memory device configured as a simple database file or as a searchable, relational database using a query language, such as SQL.

The computing device 210 can access one or more external display devices 230 such as a CRT monitor, LCD panel, LED panel, electro-luminescent panel, or other display device, for the purpose of providing information or computing results to a user. In some embodiments, the external display device 230 can actually be incorporated into the product itself. For example, the computing device 210 can be a mobile device having a display device 230. The processing unit 212 can interface to each display device 230 through a video interface 220 coupled to the processing unit 210 over the system bus 218.

In operation, the computing device 210 sends output information to the display 230 and to one or more output devices 236 such as a speaker, modem, printer, plotter, facsimile machine, RF or infrared transmitter, computer or any other of a variety of devices that may be controlled by the computing device 210. The processing unit 212 can interface to each output device 236 through an output interface 226 coupled to the processing unit 212 over the system bus 218.

The computing device 210 can receive input or commands from one or more input devices 234 such as, but not limited to, a keyboard, pointing device, mouse, modem, RF or infrared receiver, microphone, joystick, track ball, light pen, game pad, scanner, camera, computer or the like. The processing unit 212 may interface to each input device 234 through an input interface 224 coupled to the processing unit 212 over the system bus 218.

It will be appreciated that program modules implementing various embodiments of the present invention can be stored in the non-volatile memory 214, the volatile memory 216, or in a remote memory storage device accessible through the output interface 226 and the input interface 224. The program modules can include an operating system, application programs, other program modules, and program data. The processing unit 212 can access various portions of the program modules in response to the various instructions contained therein, as well as under the direction of events occurring or being received over the input interface 224.

The computing device 210 can provide data to and receive data from one or more other storage devices 232, which can provide volatile or non-volatile memory for storage and which can be accessed by computing device 210. The processing unit 212 can interface to each storage device 232 through a storage interface 222 over the system bus 218.

The interfaces 220, 222, 224, 226, and 228 can include one or more of a variety of interfaces, including but not limited to, cable modems, DSL, T1, T3, optical carrier (e.g., OC-3), V-series modems, an RS-232 serial port interface or other serial port interface, a parallel port interface, a universal serial bus (USB), a general purpose interface bus (GPIB), an optical interface such as infrared or IrDA, an RF or other wireless interface such as Bluetooth, and the like.

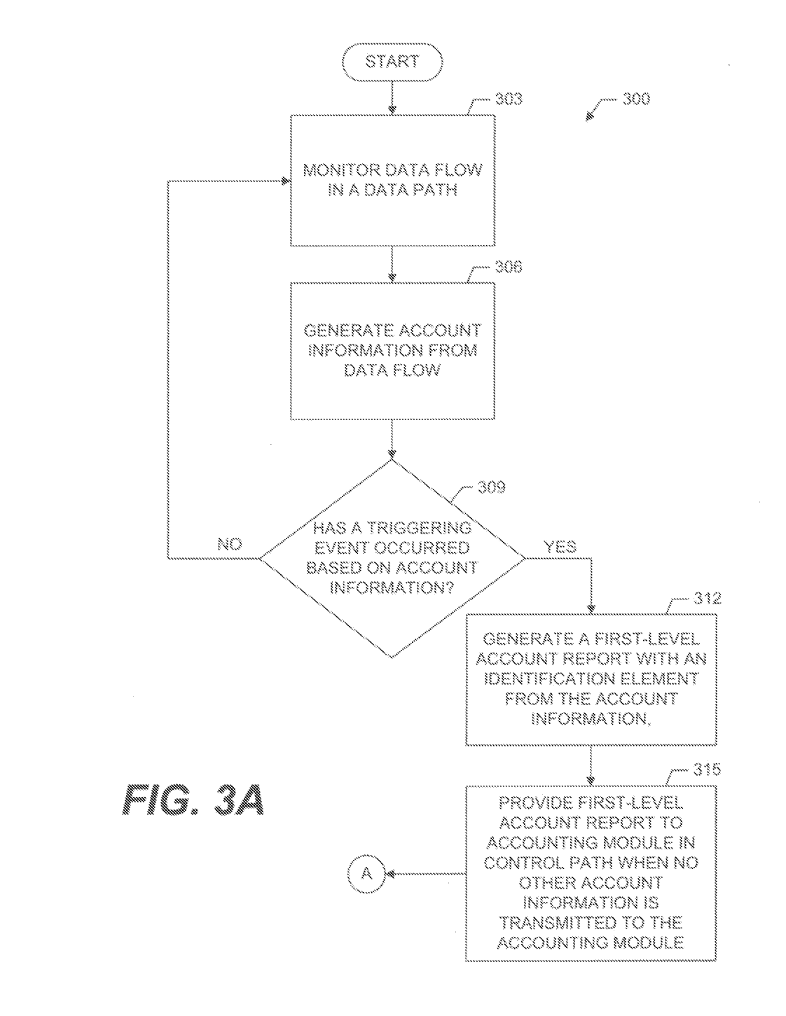

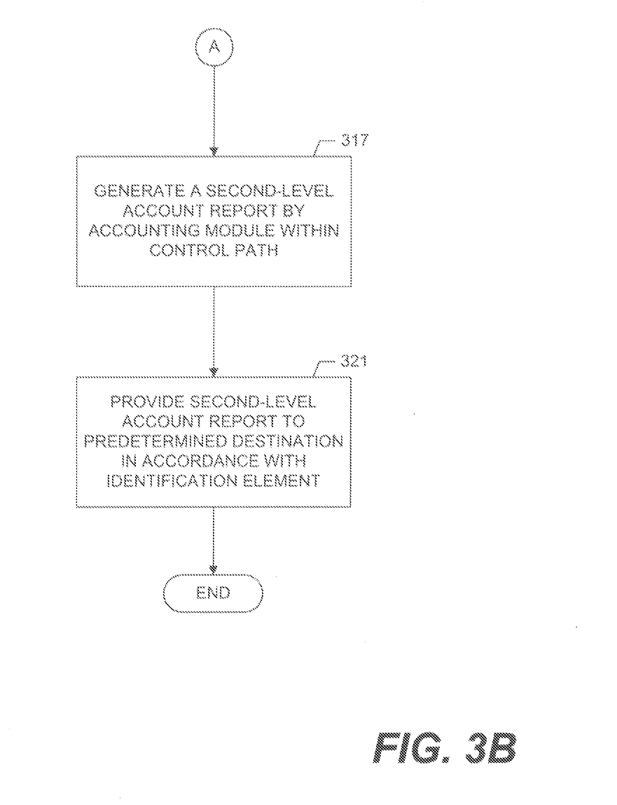

FIGS. 3A-3B, collectively known as FIG. 3, illustrate a logic flow diagram representing a first method 300 of single-channel account reporting in accordance with preferred embodiments of the present invention. The method 300 of the present invention allows the packet processing module 121 in the data-path 115 to provide a single account report to the accounting module 124 of the control-path 112, when the triggering event is required by the SCP/PPS 130, CGF 133, or both. The method 300 further optimizes the capacity of the packet switch with content-based charging functionality, by reducing the frequency in which account reports are provided to the accounting module 124.

More specifically, the method 300 of single-channel account reporting begins at 303 where the packet processing module 121 monitors a data flow in the data-path 115 between a client system 106 and a server 109. The packet processing module 121 can then generate account information at 306 from the monitored data flow. Such account information can, for example, include the number of bytes of data transferred as in the first embodiment, the number of packets of data transferred as in the second embodiment, the duration or time that data is transferred between the client 106 and the server 109 as in the third embodiment, or a combination thereof.

Next, at 309, the packet processing module 121 determines whether a triggering event has occurred based on the generated account information. A triggering event can occur when a predetermined threshold has been met or exceeded. For example, a triggering event can occur when the packet processing module 121 determines that the number of bytes of data transferred has met or exceeded a predetermined byte threshold as in the first embodiment, the number of packets of data transferred has met or exceeded a predetermined packet threshold as in the second embodiment, the duration of time of data transfer has met or exceeded a predetermined time threshold as in the third embodiment, or a combination thereof. If, at 309, the packet processing module 121 determines that a triggering event has not occurred, then the packet processing module 121, at 303, continues to monitor the data flow within the data-path 115.

If, however, at 309, the packet processing module 121 determines that a triggering event has occurred, then the packet processing module 121 creates a first-level account report from the generated account information at 312, such that the first-level account report includes an identification element. The identification element is to be used later by the accounting module 124 to determine the correct accounting destination to provide account information.

Next, at 315, the packet processing module 121 provides the first-level account report to the accounting module 124 of the control-path 112. The packet processing module 121 is adapted to provide the single first-level account report to the accounting module 124, when the triggering event is required by the SCP/PPS 130, CGF 133, or both. Accordingly, the resources of the control-path 112 are not drained as compared to multi-channel account reporting.

The accounting module 124, at 317, uses the account information within the first-level account report (including the identification element) to generate at least one second-level account report. The second-level account report is generally designated to a particular destination, as designated by the identification element. Accordingly, the accounting module 124, at 321, provides the at least one second-level account report to a predetermined destination in accordance with the identification element of the first-level account report. For example, the accounting module 124 may provide a second-level account report to the SCP/PPS 130, the CGF 133, or a combination thereof based on the direction of the identification element within the first-level account report provided by the packet processing module 121. The method 300 then terminates in accordance with the present invention.

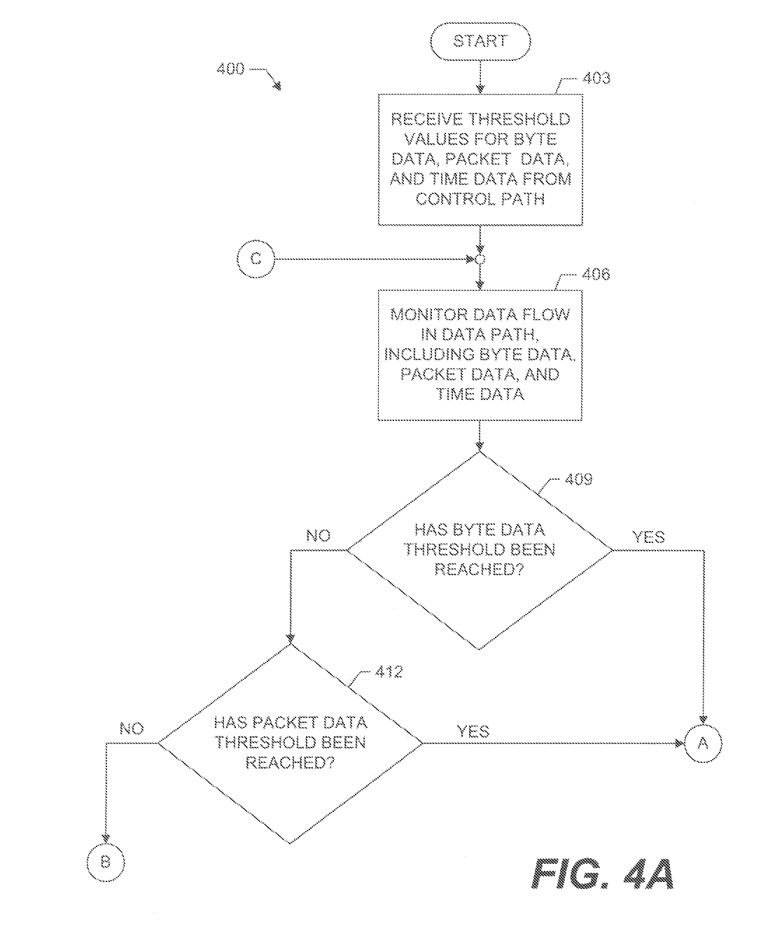

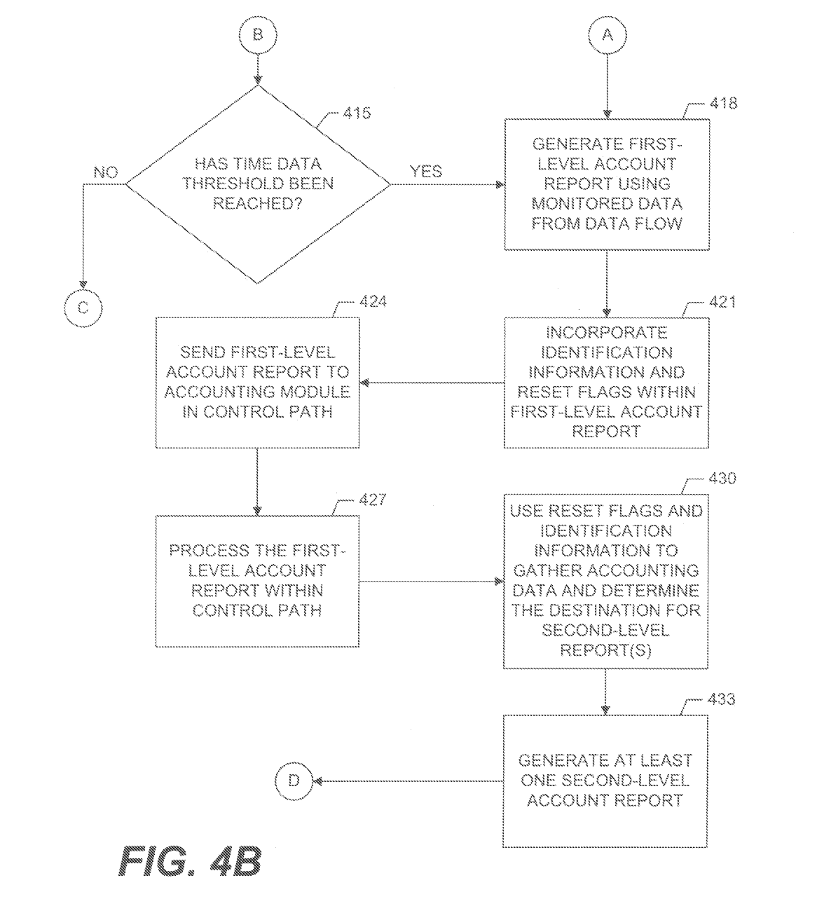

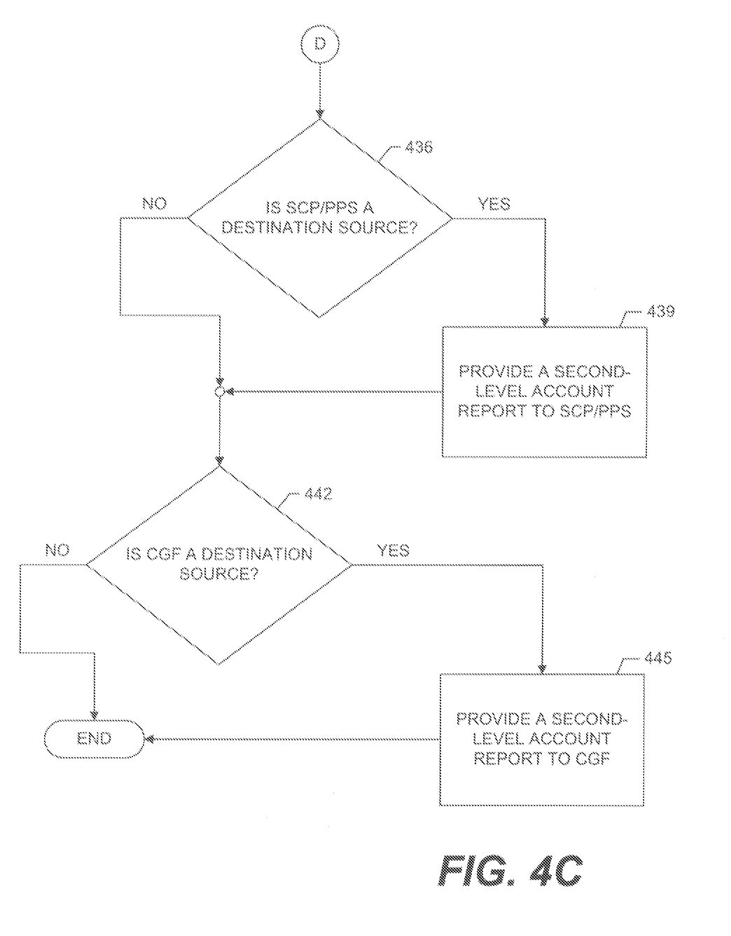

FIGS. 4A-4C, collectively known as FIG. 4, illustrate a logic flow diagram representing a second method 400 of single-channel account reporting in accordance with an exemplary embodiment of the present invention. Although similar to method 300, method 400 of the present invention provides a more detailed approach of single-channel account reporting. The method 400 allows the packet processing module 121 to received predetermined thresholds in order to determine whether a particular threshold has been met or exceeded. When a threshold has been met or exceeded, the packet processing module 121 can then gather the generated accounting information to generate a first-level account report to provide to the accounting module 124 of the control-path 112.

More specifically, the method 400 of single-channel account reporting begins at 403 where packet processing module 121 of the data-path 115 receives predetermined threshold values from the accounting module 124 of the control-path 112. The predetermined threshold values, for example, can include a byte data threshold, a packet data threshold, and a time data threshold. The predetermined threshold values provide maximum limits related to aspects of the data flow, such that a triggering event occurs when the packet processing module 121 determines that a predetermined threshold value has been met or exceeded.

At 406, the packet processing module 121 monitors the data flow within the data-path 115, whereby the packet processing module 121 can monitor, for example, the number of bytes of data transferred, the number of packets of data transferred, and the duration or time of data transfer. As the packet processing module 121 monitors the data flow, the packet processing module 121 determines, at 409, whether the byte data threshold has been met or exceeded. If, at 409, the packet processing module 121 determines that the byte data threshold has been met or exceeded, then the packet processing module 121 proceeds to 418, described below.

If, however, the packet processing module 121 at 409 determines that the byte data threshold has not been met or exceeded, then the packet processing module 121 proceeds to 412 where the packet processing module 121 determines if the packet data threshold has been met or exceeded. If, at 412, the packet processing module 121 determines that the packet data threshold has been met or exceeded, then the packet processing module 121 proceeds to 418, described below.

If, however, the packet processing module 121 at 412 determines that the packet data threshold has not been met or exceeded, then the packet processing module 121 proceeds to 415 where the packet processing module 121 determines whether the time data threshold has been met or exceeded. If, at 415, the packet processing module 121 determines that the time data threshold has been met or exceeded, then the packet processing module 121 proceeds to 418, described below. Otherwise, the packet processing module 121 continues to monitor the data flow within the data-path 115 at 406.

At 418, the packet processing module 121 generates a first-level account report using the monitored data from the data flow. Generally, the packet processing module 121 extracts account information from the data flow as it monitors the data flow at 406. The account information to be used to generate a first-level account report can include information regarding the number of bytes of data transferred, the number of packets of data transferred, or the duration of data transfer.

Next, at 421, the packet processing module 121 incorporates identification information and reset flags within the first-level account report. The identification information generally includes information that identifies a destination, such as the SCP/PPS 130, CGF 133, or both. The reset flags can include, for example, a byte reset flag, a packet reset flag, and a time reset flag associated with the number of bytes of data transferred, the number of packets of data transfer, and the duration of data transferred, respectively.

At 424, the packet processing module 121 provides the first-level account report to the accounting module 124 within the control-path 112. The packet processing module 121 is adapted to provide the first-level account report to the accounting module 124 at a time when the triggering event is required by the SCP/PPS 130, CGF 133, or both. Accordingly, the control-path 112 is not inundated with account information, thereby reducing demand on the control-path 112.

The accounting module 124, at 427, processes (within the control-path 112) the received first-level account report provided by the packet processing module 121. The accounting module 124, at 430, uses the reset flags and identification information embedded in the first-level account report to determine the appropriate destinations. Then, at 433, the accounting module 124 utilizes the first-level account report to generate at least one second-level account report to be delivered to the appropriate destination. Accordingly, if the identification information indicates that both the SCP/PPS 130 and the CGF 133 should be provided account information, then the accounting module 124 generates a separate second-level account report for each of the destinations.

At 436, the accounting module 124 uses the identification information provided in the first-level account report to determine whether the SCP/PPS 130 is a destination. If, at 436, the accounting module 124 determines that the SCP/PPS 130 is a destination, then the accounting module 124, at 439, provides a second-level account report to the SCP/PPS 130 for processing. The accounting module 124 then proceeds to 442, described below.

If, however, at 436 the accounting module 124 determines that the SCP/PPS 130 is not a destination, then the accounting module 124 proceeds to 442 where the accounting module 124 determines whether the CGF 133 is a destination. If, at 442, the accounting module 124 determines that the CGF 133 is a destination, then the accounting module 124 provides a second-level account report to the CGF 133 for processing. The method 400 then terminates in accordance with the present invention.

If, however, at 442, the accounting module 124 determines that the CGF 133 is not a destination, then the accounting module 124 terminates operation in accordance with method 400 of the present invention.

As described above, the present invention utilizes single-channel account reporting to unify the account reports of traffic statistics provided by the packet processing module 121 to the accounting module 124, such that the account report can be utilized by both the SCP/PPS 130 and the CGF 133. As only one account report is provided to the accounting module 124 at any given time, the use of control-path 112 resources is greatly reduced.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

What is claimed is:

1. A system of single channel accounting in a communication network, the system comprising:
a packet processing module for monitoring data flow within a data path between a first communication device and a second communication device, wherein the packet processing module is adapted to generate account information related to the data flow;
an accounting module within a control path, the accounting module adapted to provide the packet processing module with at least one predetermined threshold related to the data flow, wherein the accounting module is further adapted to receive a first-level account report; and
at least one destination for processing a second-level account report corresponding to the account information, wherein the second-level account report is provided by the accounting module in accordance with identification information of the first-level account report.

2. The system of claim 1, wherein the packet processing module is further adapted to determine whether the at least one predetermined threshold related to the data flow has been met or exceeded.

3. The system of claim 2, wherein the packet processing module is further adapted to provide the first-level account report to the accounting module after the at least one predetermined threshold has been met or exceeded.

4. The system of claim 1, wherein the account information includes byte information, packet information, and time information associated with the data flow.

5. The system of claim 4, wherein a first predetermined threshold relates to the byte information, a second predetermined threshold relates to the packet information, and a third predetermined threshold relates to the time information.

6. The system of claim 5, wherein the first-level account report includes a first reset flag associated with the byte information, a second reset flag associated with the packet information, and a third reset flag associated with the time information, wherein the accounting module utilizes the first reset flag, second reset flag, and third reset flag to determine how the associated account information is gathered by the control path.

7. The system of claim 5, wherein the first-level account report includes an identification element that determines at least one accounting destination in which to provide the second-level account report.

8. The system of claim 1, wherein a first destination is a service control point.

9. The system of claim 8, wherein a second destination is a prepay server.

10. The system of claim 9, wherein a third destination is a charge gateway function.

11. A method of single channel accounting in a communication network, the method comprising:
monitoring a data flow within a data path;
generating account information related to the data flow;
determining from the account information whether a triggering event has occurred; and
if the triggering event has occurred, performing a sequence comprising:
generating a first-level account report from the account information, wherein the first-level account report includes identification information;
providing the first-level account report to a control path; and
generating a second-level account report within the control path, such that the second-level account report is provided to a predetermined destination in accordance with the identification information of the first-level account report.

12. The method of claim 11, wherein the account information includes byte information, packet information, and time information associated with the data flow.

13. The method of claim 12, wherein determining from the account information whether a triggering event has occurred includes determining whether one of the byte information, packet information, and time information has met or exceeded a predetermined threshold.

14. The method of claim 11, wherein the first-level account report includes at least one flag counter associated with the account information.

15. The method of claim 11, wherein the second-level account report is provided to at least one of a service control point, a prepay server, and a charge gateway function.

16. A method of single channel accounting in a communication network, the method comprising:
monitoring a data flow within a data path;
generating account information related to the data flow, wherein the account information includes byte information, packet information, and time information associated with the monitored data flow and the account information corresponds to at least one resource accessed by a user;
determining whether one of the byte information, packet information, and time information has met or exceeded a predetermined threshold; and
if one of the byte information, packet information, and time information has met or exceeded the predetermined threshold, performing a sequence comprising:
generating a first-level account report from the account information, wherein the first-level account report includes identification information and at least one reset flag;
providing the first-level account report to a control path, such that the first-level account report is provided; and
generating a second-level account report within the control path, such that the second-level account report is provided to a predetermined destination in accordance with the identification information of the first-level account report.

17. The method of claim 16, wherein a first reset flag is associated with the byte information, a second reset flag is associated with the packet information, and a third reset flag is associated with the time information.

18. The method of claim 16, wherein the second-level account report is provided to at least one of a service control point, a prepay server, and a charge gateway function.

19. The method of claim 18, wherein the first-level account report includes account information usable by the service control point, prepay server, and charge gateway function.
